(19) United States
(12) Patent Application Publication
(10) Pub. No.: US 2007/0176462 A1
(43) Pub. Date: Aug. 2, 2007

(54) Atmospheric protection for stored vehicle

(76) Inventor: Gene Lombardo, Hailey, ID (US)

Correspondence Address: PEDERSEN & COMPANY, PLLC, P.O. BOX 2666, BOISE, ID, 83701, US

(21) Appl. No.: 11/645,103

(22) Filed: Dec. 21, 2006

Related U.S. Application Data
(60) Provisional application No. 60/753,081, filed on Dec. 21, 2005.

(51) Int. Cl. B60J 7/20

(52) U.S. Cl. 296/136.1

(57) ABSTRACT

An atmospheric and weather protection system for a vehicle includes flexible co-operating panels and cover that may be installed upon any size and shape of vehicle without employing complicated fastening and securing means such as ropes, grommets, snaps, zippers, or threaded fasteners. The lower protection panel extends underneath the vehicle and up along the sides and ends of the vehicle to be secured to the vehicle preferably by magnets and by drawstrings. The upper cover extends over the vehicle and down along the sides and ends of the vehicle to be secured to the vehicle and/or the lower protection panel by magnets, hook and loop fasteners, and/or simply ties or elastic. Thus, the preferred enclosure includes bottom vehicle over and a top vehicle cover that overlap and contact, and optionally connect to each other, along the vertical or generally vertical sides and ends of the vehicle rather than on the top of the vehicle, the roof, the hood, or the trunk lid. This overlap and securement system allows the user to install the enclosure by manipulating the enclosure members generally at a level beside the user rather than above the user, rather than requiring the user to climb up to reach the top of the vehicle.

This application claims priority of Provisional Application Ser. No. 60/753,081, filed Dec. 21, 2005, and entitled “Atmospheric Protection For Stored Vehicle,” which is hereby incorporated by reference.

### BACKGROUND OF THE INVENTION

1. Field of the Invention

The present invention relates to a stored vehicle protection system, and, more particularly, to a stored vehicle protection system that is self-contained, and is capable of cooperating with a vehicle top cover according to one embodiment of the invention, or with existing vehicle covering systems, to form an encapsulating unit.

2. Related Art

The use of protective devices for vehicles is becoming increasingly common, especially in light of the initial cost of said vehicles and the cost of repairing incurred damage. Typically, these devices are made of a flexible plastic or vinyl material that encapsulates all or part of the vehicle exterior, protecting it from sunlight, water damage, dust, dirt, and damage from insects and pests. Some of these devices are designed for the specific purpose of protecting a vehicle V in a flood situation, and may be designed to float with the vehicle as the vehicle floats in rising flood waters. (See FIGS. 1 and 2) These covering devices typically create a surrounding enclosure C after installation and have presented some problems and safety issues.

In use, a vehicle is driven onto and parked on the bottom surface of the devices shown in FIGS. 1 and 2. The sides and ends of the device are then raised and drawn up around the top of the vehicle and held in that position by a drawstring or other means, typically leaving an opening O at the top, through which undesirable elements may enter the enclosure. Such devices may include complicated fastening elements (such as F in FIG. 2) including grommets and ropes are utilized to secure the various panels and covers to one another. Especially on vehicles where considerable distance exists from the ground to the top of the vehicle, such as a pickup truck, a person may place himself in an unsafe situation using a ladder or other means to reach a position to be able to fasten the closure means at the top of said device.

Other devices and systems of this nature use a plurality of covering panels P and zippers Z to create a protective enclosure for a vehicle. (See FIG. 3). Owing to the size and shape of the panels, an enclosure according to this type of system is designed for use on only one size and shape of vehicle and cannot be used on many different vehicles.

Examples of vehicle protection apparatus are shown in the patent literature. For example:

Battle, U.S. Pat. No. 4,315,535 describes a flood protection apparatus for vehicles which comprises a unitary flexible container, like a bag, and with a drawstring top. The device of Battle is similar to that in FIG. 1 of the present application.

Allain, U.S. Pat. Nos. 6,059,105 and 6,405,862 describe motor vehicle flood protection apparatus and method where vehicle and covering means are designed to float in a flood situation and vehicle and covering means are tethered to a stationary immovable object. In Allain, there is a vehicle-receiving envelope having two rectangular plastic sheets hermetically sealed together on three sides. Or, there is an envelope of two rectangular sheets hermetically sealed at one corner and along two adjacent or intersecting sides. Both of the Allain devices are designed primarily to protect a vehicle from water damage during a flood situation. Neither of the Allain devices permit a means for preventing sagging of the lower cover assembly at its top edges when installed upon a vehicle, and both do not provide a means of adequately securing the drawstring apparatus, thereby allowing the cover assembly to possibly become loose and sag, allowing water within.

Harmon, U.S. Patent U.S. 2005/0139300 A1 describes a protective vehicle cover and method for protecting the interior of a vehicle from water damage from rising flood waters. In Harmon, the perimeter of the cover is provided with grommets which provide holes for threading a rope to tighten or straps. The Harmon device is similar to that shown in FIG. 2 of the present application.

Su, U.S. Pat. No. 6,517,141 B1 describes a waterproof car covering including integral waterproof panels that have peripheral side edges connected to form a continuous loop. A closure unit in the loop includes interlocking engageable male and female members (zippers) extending around periphery of panels to enclose the vehicle. The Su device is similar to that shown in FIG. 3 of the present application.

Still, there is needed an improved vehicle protective enclosure that is secure, easy and safe to install, and that reliably shields the vehicle from rain, snow, wind, and other atmospheric and weather assaults on the vehicle or its finish.

### SUMMARY OF THE INVENTION

The present invention comprises a stored vehicle protection system that shields a vehicle from, and preferably seals out, the damaging effects of the atmosphere. The protection system comprises a protective panel that is installed on a lower portion of a vehicle and fastened/held on the vehicle at a position(s) about midway along the sides and ends of the vehicle. The protective panel is preferably used in combination with a vehicle top cover that is laid over the top of the vehicle to hang down along the sides and ends of the vehicle, over the upper region of said protective panel. This combination may cover the entire vehicle so that the protection system comprises an enclosure for the vehicle. The fasteners, closures, and/or other connections between the protective panel and the top cover, and/or between the panel-cover-combination and the vehicle, are preferably entirely or at least substantially at the sides and ends of the vehicle on generally vertical portions of the vehicle and at a level(s) that is/are easy for a user to reach without climbing.

The preferred embodiments leave no openings into the protective enclosure through which potentially damaging effects of atmosphere and surroundings may easily enter. There are preferably no openings in the protective enclosure at or near the top of the vehicle or at or near any horizontal or generally horizontal portion of the vehicle, so that rain or snow resting or pooling on horizontal portions of the protective enclosure does not enter opening into the enclosure.

The protective panel preferably comprises a flat, planar panel made of plastic, vinyl, or similar smooth, strong material that is resistant to the effects of sunlight, water, dirt and chemicals. The panel is designed and of a composition so that, when installed, it has no detrimental effects upon the exterior components or finish of a vehicle. The central portion of the panel (bottom portion, when installed on the vehicle), upon which the vehicle is driven and parked, should be strong enough to accept the weight of the vehicle, and the scuff of the vehicle tires, without being compromised.

The preferred protective panel includes two side portions and two end portions that extend from the central portion and that are integral parts of the protective panel. The side and end portions are flexible and strong and are designed to be folded up along the sides and ends of a vehicle and secured snugly to the vehicle.

The protective panel may include a series of magnets contained and secured inside the edge regions of the side portions (top edges when the panel is installed on the vehicle). Alternatively, instead of magnets inside portions of the outer edge regions, the vehicle protection system may include magnets that are separate from, and unattached to, the panel. The magnets, whether inside a pocket in the panel or otherwise attached to the panel, or simply laid against the panel during installation of the panel on the vehicle, serve to connect and continually hold the side portions of the panel snugly on the sides and/or the ends of the vehicle until the user purposely removes the magnets and the protective enclosure from the vehicle. The magnets may eliminate the need for complicated and potentially damaging fastening systems and may prevent the side portions of the protective panel from sagging downwardly, gaping away from the vehicle, or becoming detached from the vehicle.

Preferably, the protective panel includes a securing means comprising one or more flexible, elastic drawstrings. Each drawstring may be contained within a continuous interior channel/tubular space at the top edges of the sides and ends of the panel. Each drawstring may comprise a portion or portions that protrude from the protective panel so that the user may access the drawstring to tighten and secure the drawstring to tighten the protective panel around the vehicle. The drawstring(s) serve(s) to snugly conform the flexible side and end portions of the protective panel to the various contours of the exterior of the vehicle, so that the protective panel is held snugly against generally vertical surfaces of the vehicle and/or preferably just above the rear and front bumpers of the vehicle.

The vehicle protection system may include a vehicle positioning means to aid a driver in correctly centering the vehicle upon the bottom portion of the panel. This means may include, but is not limited to, a pole(s) or stanchion(s) which may be temporarily secured upon the panel at a point on or near the front end portion of the panel and removed for storage after use. Alternatively, the positioning means may comprise multiple poles, guides, or other markers or indicators that are visible to the driver when he/she is driving the vehicle onto the panel. Such means may allow a user to drive onto and install the protection system without the help of another person.

Preferably, the protective panel does not include any fastening means other than the aforementioned magnets and drawstring means for connecting or fastening the protective panel to the vehicle. Also, preferably, the protective panel has no eyelets, grommets, seams for zippers, or other openings.

The protective panel may be used in cooperation with other vehicle covers, including a conventional vehicle top cover such as may be purchased in many automobile parts or accessory stores, to completely encapsulate the vehicle for protection. Or, the protective panel may be used with a specially-adapted top cover according to alternate embodiments of the invention.

### BRIEF DESCRIPTION OF THE DRAWINGS

FIG. 1 is a perspective view of one prior art protection means installed on a vehicle, designed primarily for flood situations.

FIG. 2 is a perspective view of another prior art protection means installed on a vehicle, also designed primarily for flood situations.

FIG. 3 is a perspective view of another prior art protection means being installed on a vehicle, designed primarily for the size and shape of a particular vehicle.

FIG. 4 is a rear perspective view according to one embodiment of the present invention, wherein one embodiment of a protective panel is installed underneath the vehicle and extending up along the sides and ends of the vehicle to a location just above the level of the vehicle bumpers and with the drawstring shown schematically (or not yet tightened). A cut-away view of one embodiment of a top cover is also included in this figure, across the front of the vehicle and extending down along the side and end of the vehicle past the top edge of the protective panel. The vehicle portions underneath the protective panel and underneath the top cover portion are shown in dashed lines.

FIG. 5 is a plan view of the protection panel embodiment of FIG. 4, not installed on a vehicle but rather laid-out flat, wherein this embodiment includes pocket(s) containing magnets and includes a single drawstring.

FIG. 5A is a plan view of an alternative embodiment of the invented protection panel, not comprising any magnets inserted into the panel and comprising a plurality of drawstrings.

FIG. 6 is a side cross-sectional elevation view of the general shape/profile of one embodiment of the invented protection panel, installed on a vehicle in combination with one embodiment of a vehicle top cover. In this figure, one may see in solid lines: the vehicle, portions of the protection panel underneath the vehicle and at the ends of the vehicle, and portions of the top cover above the vehicle and at the ends of the vehicle. In this figure, one may see in dashed lines: the protection panel's top edge, magnets, and hook and loop fasteners (for connection to the top cover), which dashed lines result from the protection panel and top cover having been cut away from the side of the vehicle that is being viewed in this figure.

FIG. 7 is a rear cross-sectional elevation view of the general shape/profile of the embodiment of FIG. 6, viewed along the line 7-7 of FIG. 6.

FIG. 8 is a cross-sectional, partial view of one end portion of the protection panel of FIG. 5, viewed along the line 8-8 in FIG. 5.

FIG. 9 is a cross-sectional, partial view of one side portion of the protection panel of FIG. 5, viewed along the line 9-9 in FIG. 5.

FIG. 10 is a perspective detail view showing one embodiment of a securing means for a drawstring that may be used on the preferred protection panel.

FIG. 11 is a cross-sectional, partial view of the embodiment of FIG. 5, shown installed on a vehicle in combination with one embodiment of a top cover, wherein the protection panel is secured to the vehicle by a drawstring(s) and internal magnets in pockets of the panel, and wherein the top cover is connected to the protection panel by hook and loop fasteners. Note that these connections/securement systems are all on/against generally vertical panel(s) of the vehicle.

FIG. 11A is a cross-sectional, partial view of the embodiment of FIG. 5A, shown installed on a vehicle in combination with one embodiment of a top cover, wherein the protection panel is secured to the vehicle by a drawstring(s) and exterior magnets, and wherein the top cover is connected to the protection panel by hook and loop fasteners. Note that these connections/securement systems are all on/against generally vertical panel(s) of the vehicle.

FIG. 12 is a cross-sectional elevation, partial view showing one embodiment of a visual positioning stanchion.

FIG. 13 is a detail view of the connection system of FIG. 11 for connecting the protection panel to the top cover.

### DESCRIPTION OF THE PREFERRED EMBODIMENTS

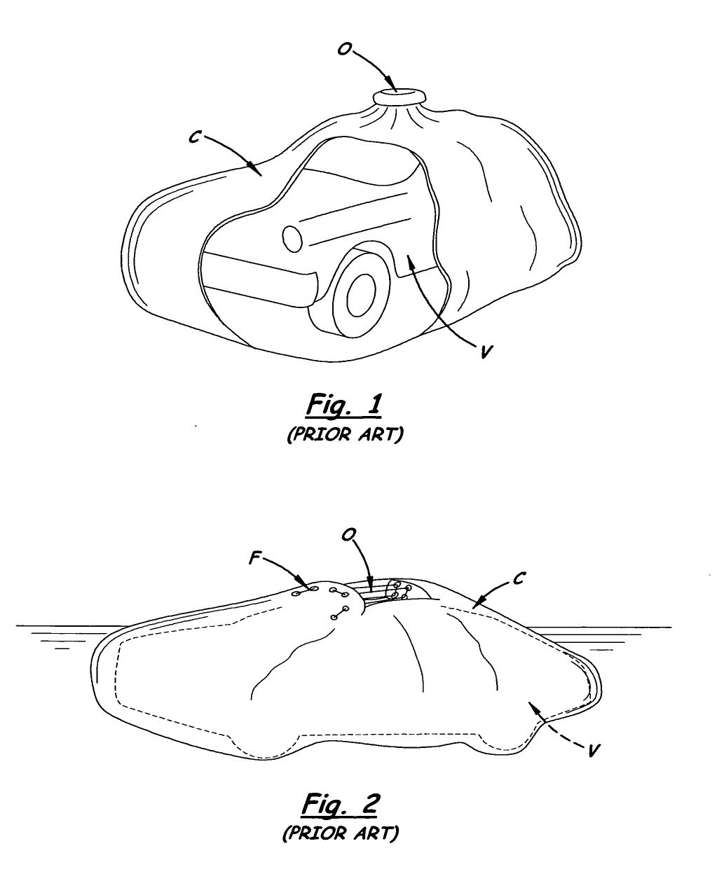

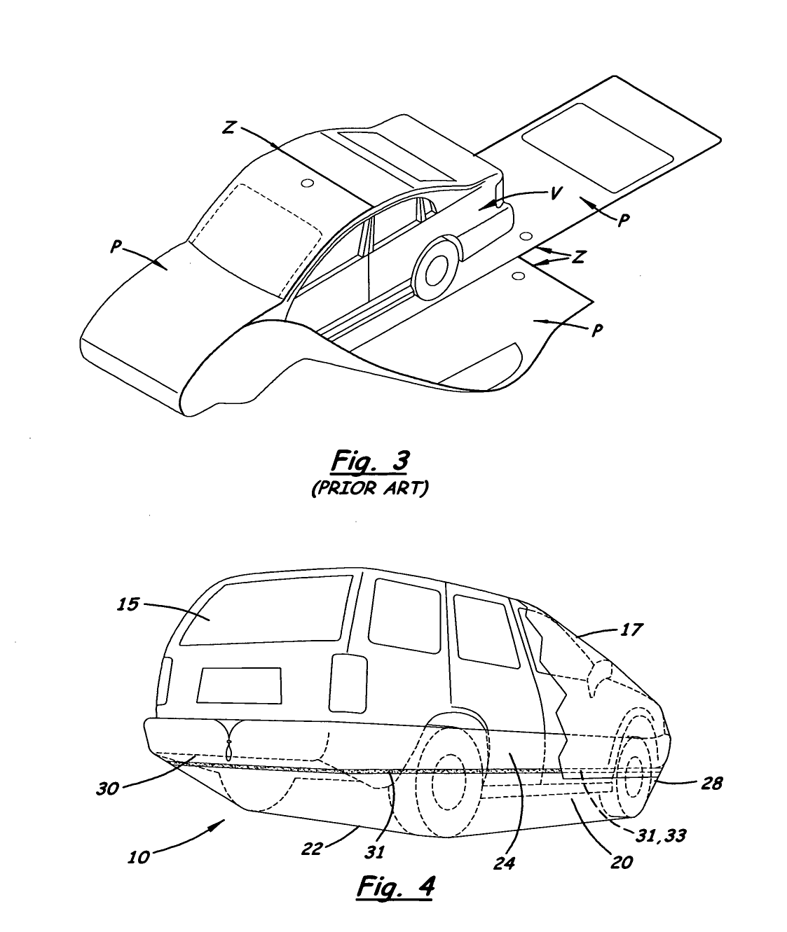

Referring to FIGS. 1, 2, and 3, there are shown embodiments of prior art vehicle protection systems. Referring to FIGS. 4-13, there are shown several, but not the only, embodiments of the invented vehicle protection system that may be used for encapsulating a vehicle such that it is protected from detrimental effects of the atmosphere and surroundings, including, but not limited to, water damage, sunlight, dirt, dust, chemicals, salt air, air pollution, tree sap, insects and other pests. The prior art systems are discussed in the Related Art section, above.

The preferred vehicle protection system 10 comprises protection panel 20 and top cover 17. Panel 20 includes a plurality of cooperating and integral panel portions comprising a bottom portion ringed by side and end portions that bend/fold upwards to extend along the sides and ends of the vehicle, respectively. Both the protection panel 20 and separate but preferably-cooperating top cover 17 are preferably made of plastic or vinyl, or other materials that exhibit the desired flexibility, resilience and resistance to tearing or cracking when flexed, that are waterproof, and that also exhibit desired longevity characteristics to resist the effects of ageing and the detrimental effects of the atmosphere and surroundings.

In FIG. 4, panel 20 is shown installed and secured upon the bottom portion of a vehicle 15 and a portion of top cover 17 is shown installed over the top of the vehicle 15 and secured to the sides of panel 20. The panel 20 preferably is underneath the entire vehicle and also extends up along the sides and ends of the vehicle to reach to a level about ⅓-⅔ of the way from the bottom of the vehicle wheels to the uppermost extremity of the vehicle (typically the top of the roof). More preferably the panel 20 extends to just above the bumpers so that its uppermost perimeter edge circles the vehicle just above the bumpers. The top cover preferably covers the entire top of the vehicle and extends down along the sides and ends of the vehicle to reach a level about ½ to ¾ of the way from the uppermost extremity of the vehicle (typically the top of the roof) to the bottom of the wheels. The top cover may extend down toward the vehicle bottom and even be tied or elastically-biased to curve inward a short distance along the bottom of the vehicle. In doing so, the top cover extends over (outside) and down past a portion of the panel 20. This way, the cover 17 and the panel 20 overlap, preferably several inches up to about 3 feet (most preferably 4 inches up to 24 inches), at the generally vertical sides and ends of the vehicle. This preferred region of overlap of the panel and cover may be said to be generally midway vertically on the vehicle.

Preferably, the panel 20 nor the cover 17 are continuous sheets that do not have any apertures, openings, or zippered seams; they curve or drape to allow them to be placed around approximately a bottom half of the vehicle (the panel 20) and the top half of the vehicle (the cover 17). This way, the transition between the panel 20 and cover 17 is an overlap (with optional fastening between them at that overlap) of vertical or generally vertical portions of the panel 20 and cover 17, and this transition is unlikely to allow damaging elements or contaminants between the panel 20 and cover 17 into the enclosure created by said panel and cover.

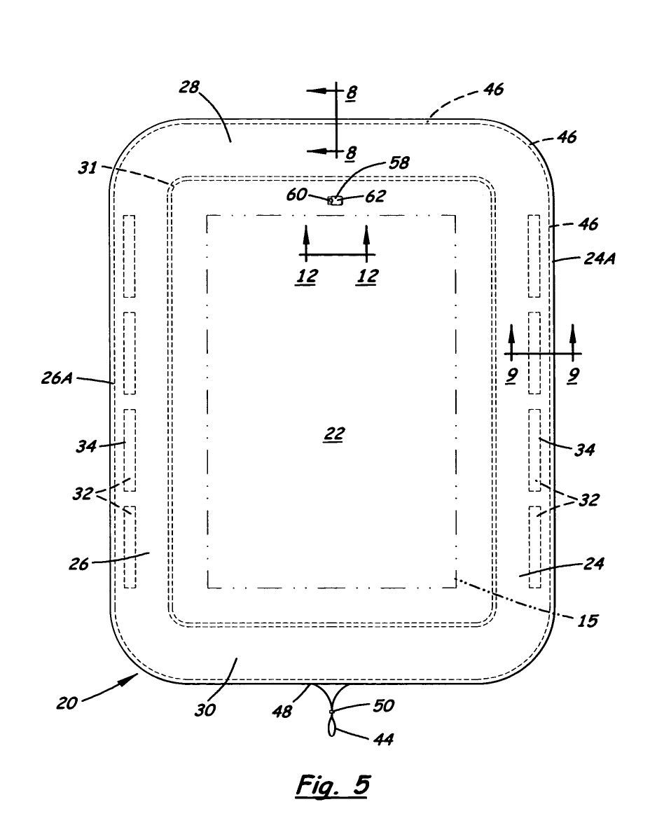

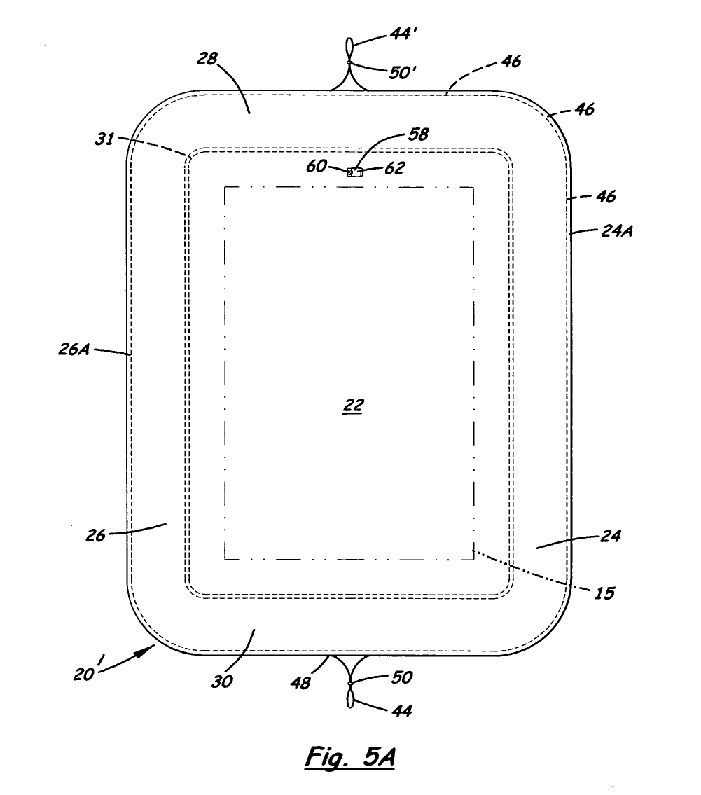

Referring specifically now to FIG. 5, panel 20 comprises bottom portion 22, side portions 24 and 26, and end portions 28 and 30, wherein all of these portions are preferably integral portions of a single, continuous sheet or layered sheets. In use, panel 20, comprised of all of its portions, is laid flat and spread out upon a floor or the ground. A visual positioning stanchion 60 may be temporarily attached to bottom portion 22 (or other suitable reference point on the panel 20) and is used by the driver as a visual aid (or even a contact aid whereby the driver proceeds until the stanchion is tapped by the bumper) in correctly centering the vehicle upon bottom portion 22. (See FIG. 12 for one example).

A vehicle 15 is driven onto and parked upon bottom portion 22, wherein bottom portion 22 should be thick enough and strong enough and constructed of a suitable material so as to accept forces associated with driving and parking a vehicle upon it. The bottom portion 22 may be thicker and heavier than the side and end portions, if needed, to fulfill this durability goal. The bottom portion 22 shall be suitably constructed so as to resist puncture and to withstand the weight of a vehicle at the concentrated force areas (the tires) upon the bottom portion for indefinite periods of time. This suitable construction may include, but is not limited to, strong, durable, puncture-resistant upper and lower outer layers comprised of plastic, vinyl, flexible fiberglass or similar materials, with inner reinforcing layers comprised of fiberglass, flexible metal mesh, Kevlar™, nylon, rayon or similar materials.

After the vehicle is in place generally centered on the panel, the positioning stanchion 60 may then be removed for storage within or under the vehicle. It is noteworthy that the preferred stanchion attachment or anchoring preferably does not result in an aperture through the panel, at least not any aperture that will allow any significant leak into the enclosure. In such an attachment and other portions of the panel and/or cover, even if there are holes to receive stitching thread or other fasteners extending through the panel, said holes are very small and tightly receiving the thread or fasteners so as to not be significant leak risks.

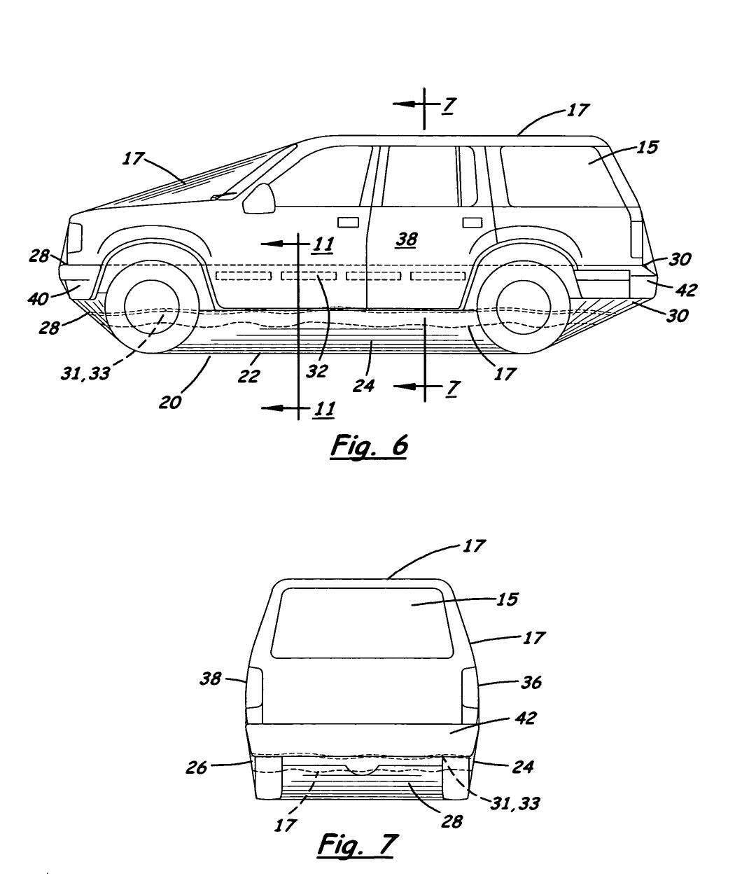

Referring now to FIGS. 6, 7 and 11, side portions 24 and 26, and end portions 28 and 30, are now raised vertically upwards and toward the sides and ends of the vehicle 15. Within the upper edges 24A and 26A of panel portions 24 and 26 are magnets 32, used to secure the upper edges 24A and 26A to the metallic sides of the vehicle 36 and 38. Magnets 32 are contained within pockets in the panel or otherwise attached to the panel and so may be considered internal to, or integral with, upper edges 24A and 26A of panel portions 24 and 26. The magnets are preferably aligned in a series to run the length of upper edges 24A and 26A, contained within pockets 34. Magnets 32 may be secured in pockets 34 by the use of sewing or adhesive or by other means.

FIG. 5A illustrates a panel 20′ that does not include interior or integral magnets, but instead may be used with separate magnets 32′ provided as a part of a kit, for example. Such separate magnets 32′ are not received in any pocket and not attached to the panel 20′ except that they may be placed on the outer surface of the panel 20′ to adhere against the outer surface of the panel 20′ by magnetic attraction to the vehicle panel on the other side of the panel 20′. See this arrangement and method portrayed in FIG. 11A. Such separate magnets 32′ may be placed around the side (and optionally the end) portions of the panel 20′ as desired by the user to secure the panel 20′ to the vehicle and to prevent the panel 20′ from sagging or gapping away from the vehicle.

End portions 28 and 30 of panel 20 are designed preferably to be wrapped up and over and secured snugly against the front bumper 40 and rear bumper 42 of the vehicle 15. Securing of the side portions 24 and 26, and end portions 28 and 30, snugly along the sides of the vehicle 36 and 38, and bumpers of the vehicle 40 and 42, may be accomplished by means of a drawstring 44 in the embodiment of FIG. 5 (or multiple drawstrings 44, 44′ in FIG. 5A). When combined with the magnet system (magnets 32, 32′), the panel 20, 20′ is securely and snugly secured to the vehicle, even through this securement is preferably entirely provided around generally vertical surfaces of the vehicle. The end portions of the panel 20, 20′ may reside above or resting on the top surfaces of the bumpers (which in some model vehicles may be considered horizontal) but, still, this securement may be considered to be at or on the generally vertical ends of the vehicle rather than the generally horizontal top of the vehicle (roof, hood, or trunk lid).

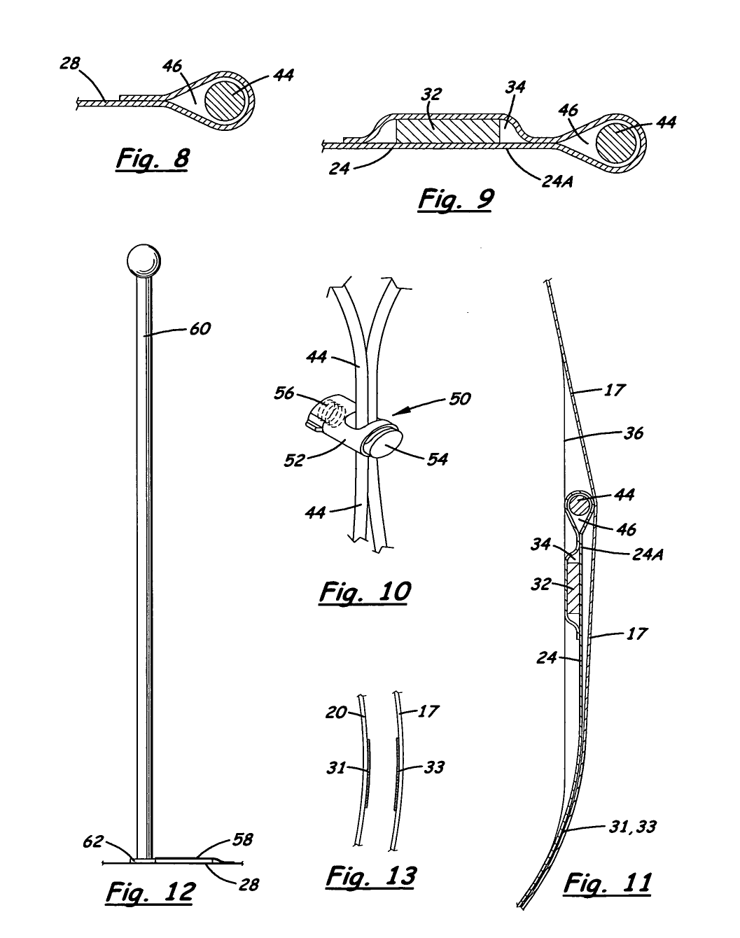

Referring now to FIG. 5, and FIGS. 8 and 9, drawstring 44 passes unendingly through passage 46 which runs continuously along the top edges of side portions 24 and 26 and end portions 28 and 30 of panel 20. The drawstring 44 exits at the top edge of end portion 30 at two holes 48, but is not limited to exiting at this point and other points may be used. The drawstring 44 may be pulled tight to snugly secure side portions 24 and 26 and end portions 28 and 30 of panel 20 against vehicle 15. A spring-loaded securing device 50 may be used to keep the drawstring tight but other devices may be used to accomplish this.

FIG. 5A illustrates an embodiment that uses more than one drawstring and wherein each drawstring extends only part way around the panel. In panel 20′, one drawstring is provided for each half (end) of the panel 20′, wherein each drawstring may be anchored to the panel generally midway from the front of the panel to the rear (preferably inside a passage or passages similar to passage 46 in FIG. 5). Each drawstring extends toward its respective end to exit at the end for access by the user. Thus, as one may see in FIG. 5A, the user may need to tighten two drawstrings to properly snug the panel 20′ around the vehicle, but the inventor believes that this system allows for better tightening of the drawstring system. The inventor believes that two drawstrings will be optimal, but more or fewer may be used, as may be drawstring(s) that are provided in, or exit the panel at, different locations of the panel.

Referring now to FIG. 10, one version of a spring-loaded drawstring-securing device consists of a body 52, a sliding keeper 54, and spring 56. When keeper 54 is depressed against the pressure of spring 56, the drawstring 44 is allowed to move within keeper 54. When keeper 54 is released, spring pressure does not allow movement of drawstring 44 within securing device 50.

Referring now to FIG. 12, visual positioning stanchion 60 may be utilized by placing end 62 temporarily within flap 58 which is attached to end portion 28 of panel 20. As stated above, stanchion 60 is removed for storage after vehicle 70 has been positioned on panel 20.

Referring again to FIGS. 5, 5A, and 6, the protection panel 20, 20′ is preferably used in conjunction with a vehicle cover 17 which is installed from the top and pulled down along the sides and ends of vehicle 15 to overlap the top edges of side portions 24 and 26 and end portions 28 and 30 of panel 20, completing the envelopment of the vehicle to protect against atmospheric and surrounding conditions.

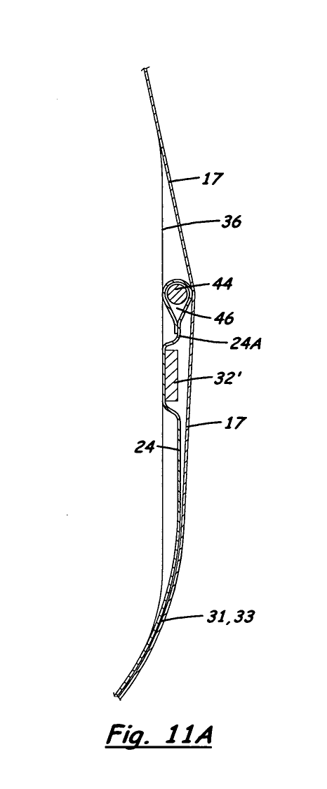

Referring now to FIG. 13, specially-adapted cover 17 according to one embodiment of the invention is attached to side portions 24 and 26, and end portions 28 and 30, of panel 20, preferably utilizing a hook and loop type (such as Velcro™) of fastening system, however, other fastening means may be employed. The preferred fastening system between panel 20, 20′ and cover 17 comprises a continuous hook/loop strip 31 attached to side and end portions of panel 20, 20′ utilizing thread or adhesive or other means, and a continuous cooperating hook/loop strip 33 attached to cover 17 utilizing thread or adhesive or other means. Fastening strips 31 and 33, when engaged with one another, provide a snug joint between top cover 17 and bottom panel 20, unlikely to blow apart in wind.

Top cover 17 may also include magnets (not shown), installed within and arranged similarly to magnets 32 in side portions 24 and 26 of bottom panel 20. The magnets in top cover 17 may be arranged so as to make contact with and adhere to magnets 32 in the bottom panel when both cover assemblies are installed upon the vehicle. Alternately, the magnets in the top cover may be arranged so as to make magnetic contact (if not direct physical contact) with the metal panels of the vehicle, the magnetic force acting through bottom panel 20, preferably at a point lower than the magnets 32 in the bottom panel 20. Thus, the magnets in top cover 17 may be used in conjunction with hook and loop or other fastening and securing means to provide a snug fit between top and bottom cover assemblies

Alternatively, a simple conventional vehicle top cover, available commercially, may be used in conjunction with the panel 20, 20′, said conventional top cover not having any system for connecting to the panel 20, 20′ but optionally having ties, cords, elastic, or other tethers to help keep it on the vehicle and held down over the side and end portions of the preferred panel 20, 20′. Therefore, the panel system 20 may be used in cooperation with existing vehicle covers that install over the vehicle from the top and use a securing means such as elastic or ties at their open, bottom edges.

The preferred enclosure may be described as including a bottom vehicle cover (or “panel”) and a top vehicle cover that contact and overlap, and that optionally attach to each other, along the vertical or generally vertical sides and ends of the vehicle rather than on the top of the vehicle (specifically, rather than on the roof, the hood, or the trunk lid). The preferred overlap and securement system allows the user to install the enclosure by manipulating and securing the enclosure members (bottom cover/panel and top cover) generally at a level beside the standing user (preferably at about waist or hip level rather than significantly above or below the user's torso), for example, rather than requiring the user to climb up to reach the top of the vehicle. The bottom cover preferably does not reach to, and does not contact, the vehicle top (neither the vehicle roof, the trunk lid, nor the vehicle hood). The top cover may extend part way across the bottom of the vehicle, but preferably not all the way across the vehicle bottom. While the term “portions” may be used, especially to describe regions of the protection panel, both the bottom cover and the top cover are preferably each a continuous, one-piece panel with few or no seams, as seams between multiple pieces might make the covers more prone to leaking. The preferred vehicle protection system is safe and easy to use and completely encapsulates the vehicle to protect the exterior and interior of said vehicle from detrimental effects of the atmosphere such as sunlight, water, dirt, air pollution, insects, and pests.

The term “generally vertically” refers to surfaces or portions that are more vertical than horizontal, for example, at less than 45 degrees away from true vertical.

Although this invention has been described above with reference to particular means, materials and embodiments, it is to be understood that the invention is not limited to these disclosed particulars, but extends instead to all equivalents within the scope of the following claims.

I claim:

1. A vehicle protection system for protecting a vehicle from weather and atmospheric contaminants, the vehicle having a bottom, sides, ends, and a vehicle top, the protection system comprising:
a bottom protection panel being adapted to extend underneath a vehicle and up along the sides and ends of the vehicle;
a top cover, separate from the bottom protection panel, being adapted to extend over the vehicle top and down along the sides and ends of the vehicle to extend over said protection panel a distance so that the top cover overlaps said bottom protection panel in a generally vertical region of both the cover and the protection panel;
said bottom protection panel further comprising a drawstring adapted to tighten said bottom protection panel around the sides and ends of the vehicle; and
magnets provided against the bottom protection panel for magnetically adhering to metallic portions of the vehicle sides.

2. A vehicle protection system as in claim 1, wherein the magnets are inside pockets in the bottom protection panel.

3. A vehicle protection system as in claim 1, wherein the magnets are separate from, but contacting, the bottom protection panel.

4. A vehicle protection system as in claim 1, further comprising hook and loop fasteners between, and releasably connecting, said bottom protection panel and said top cover.

5. A vehicle protection system as in claim 1, further comprising a centering device connected to the bottom protection panel prior to installation of said panel on the vehicle, to aid in placement of a vehicle to be protected onto said bottom protection panel.

6. A vehicle protection system for protecting a vehicle from weather and atmospheric contaminants, the system comprising:
a vehicle having a bottom, sides, ends, a vehicle top, and tires having bottom surfaces;
a bottom protection panel extending underneath the vehicle and up along the sides and ends of the vehicle but not extending to contact the vehicle top;
a top cover extending over the vehicle top and down along the sides and ends of the vehicle and extending over said protection panel a distance so that the top cover overlaps said bottom protection panel in generally vertical regions of both the cover and the protection panel, said generally vertical regions of both the cover and the panel are positioned over generally vertical sides and ends of the vehicle;
said bottom protection panel further comprising at least one drawstring tightening said bottom protection panel around said sides and ends of the vehicle; and
magnets against the bottom protection panel magnetically attracted to metallic portions of the vehicle sides and securing the bottom protection panel between said magnets and said vehicle sides so that the bottom protection panel is held snugly against the vehicle sides.

7. A vehicle protection system as in claim 6, further comprising hook and loop fasteners in the region of the overlap of said bottom protection panel and said top cover, to connect said panel and said cover.

8. A vehicle protection system as in claim 6, wherein an uppermost perimeter edge of the bottom protection panel is located at a location ⅓-⅔ of the way from the vehicle tire bottom surfaces to the uppermost extremity of the vehicle top.

9. A vehicle protection system as in claim 6, wherein a lowermost perimeter edge of the top cover is located at a location ½-¾ of the way from the topmost extremity of the vehicle top to the vehicle tire bottom surfaces.

10. A vehicle protection system as in claim 6, wherein said top cover is a sheet with no apertures.

11. A vehicle protection system as in claim 6, wherein said top cover has no zippers.

12. A vehicle protection system as in claim 6, wherein said bottom protection cover has no zippers.

13. A vehicle protection system for protecting a vehicle from weather and atmospheric contaminants, the system comprising:
a vehicle having a bottom, sides, ends, a vehicle top, and tires having bottom surfaces;
a bottom protection panel extending underneath the vehicle and up along the sides and ends of the vehicle;
a top cover extending over the vehicle top and down along the sides and ends of the vehicle and extending over said protection panel a distance so that the top cover overlaps said bottom protection panel in generally vertical regions of both the cover and the protection panel, said generally vertical regions of both the cover and the panel being positioned over generally vertical sides and ends of the vehicle;
wherein the system comprises a securement system for retaining said bottom protection panel and said top cover on the vehicle, said securement system consisting essentially of:
said bottom protection panel comprising at least one drawstring tightening said bottom protection panel around said sides and ends of the vehicle;
magnets against the bottom protection panel magnetically attracted to metallic portions of the vehicle sides and securing the bottom protection panel between said magnets and said vehicle sides so that the bottom protection panel is held snugly against the vehicle sides; and
hook and loop fasteners connecting said bottom protection panel and said top cover where they overlap.

14. A vehicle protection system as in claim 13, wherein said securement system includes two independent drawstrings, one at each end of the bottom protection panel.

15. A vehicle protection system as in claim 13, wherein the magnets are received in pockets in said panel.

16. A vehicle protection system as in claim 13, wherein the magnets are separate from said bottom protection panel and said top cover and are placed against the bottom protection panel for holding said panel between said magnets and said vehicle sides.

17. A vehicle protection system as in claim 13, wherein the bottom protection panel is a continuous, flat sheet without apertures.

18. A vehicle protection system as in claim 13, wherein the top cover is a continuous, flat sheet without apertures.

19. A vehicle protection system as in claim 13, wherein said at least one drawstring tightens the bottom protection panel around the vehicle just above front and rear bumpers of the vehicle and an uppermost perimeter edge of the bottom protection panel is just above said front and rear bumpers.

20. A vehicle protection system as in claim 13, wherein the bottom protection panel comprises a visual aid for assisting in centering the vehicle on the panel, the aid upending from the panel prior to installation of the panel on the vehicle, said visual aid upending to a level whereby a driver of the vehicle sees the aid when driving the vehicle onto the panel.
